(19) United States
(12) Patent Application Publication
(10) Pub. No.: US 2016/0133118 A1
(43) Pub. Date: May 12, 2016

(54) PROXIMITY NOTIFICATION SYSTEM

(71) Applicant: COMMAND SMART, LLC, Massillon, OH (US)

(72) Inventors: Andrew James Forchione, Massillon, OH (US); Eugene Angelo Forchione, Massillon, OH (US)

(73) Assignee: Command Smart, LLC

(21) Appl. No.: 14/937,276

(22) Filed: Nov. 10, 2015

Related U.S. Application Data
(60) Provisional application No. 62/077,613, filed on Nov. 10, 2014.

(51) Int. Cl. G08B 21/24; G01S 19/51

(52) U.S. Cl. CPC G08B 21/24; G01S 19/51

(57) ABSTRACT

A system and method for determining movement from a defined region and that an event trigger has occurred. A proximity notification system includes a first device and a second device. In an example embodiment, the first device is a handheld electronic device that has a global positioning system (GPS). The second device has a proximity connection with the first device. The proximity connection can be a wireless Bluetooth type of connection, a physical switch type of connection or another type of connection. The first device generates a message for a user of the first device upon the GPS detecting that the first device has moved from a predetermined area and that the proximity connection between the first device and the second device has been lost.

### CROSS-REFERENCE TO RELATED APPLICATION

This application claims priority to U.S. Provisional Patent Application Ser. No. 62/077,613, filed on Nov. 10, 2014; the disclosure of which is entirely incorporated herein by reference.

### BACKGROUND

1. Technical Field

The current disclosure relates generally to apparatus, systems and methods for notifying a person about an event. More particularly, the apparatus, systems and methods relate to notifying a person about an event when the person leaves a specific area and a second trigger is activated. Specifically, the apparatus, systems and methods provide for a global positioning system (GPS) and a wireless network triggering a notice to be sent to a person.

2. Background Information

In the modern world with a wide variety of electronic devices it is easy for a person to misplace their smartphone, laptop computer or other type of electronic device. Additionally a person may accidently leave their house without an electronic device or leave home without first checking a list that they were to review before leaving home. Global positioning systems (GPS) and devices that have GPS technology built into them are useful for telling a person where they are located. GPS devices are now built into phones, laptops and other electronic devices. While GPS devices are useful for reminding one where they are located, they are not useful for reminding someone that they have abandoned/forgot their electronic device or to remind them of another type of event. What is needed is a better way for reminding a person about a particular event at the correct time.

### SUMMARY

One aspect of an embodiment of the present disclosure includes a system for determining movement from a defined region and that an event trigger has occurred. A proximity notification system includes a first device and a second device. In an example embodiment, the first device is a handheld electronic device that has a global positioning system (GPS). The second device has a proximity connection with the first device. The proximity connection can be a wireless Bluetooth type of connection, a physical switch type of connection or another type of connection. The first device generates a message for a user of the first device upon the GPS detecting that the first device has moved from a predetermined area and that the proximity connection between the first device and the second device has been lost.

Another embodiment may provide for a method of determining if a GPS trigger and an event trigger (e.g., state trigger) have both occurred and then generating an appropriate response. The method begins defining a GPS trigger and a low power wireless network (LPWN) trigger as set by a user of a wireless handheld device. As mentioned below, the wireless handheld device could be any device that has GPS capabilities and the LPWN trigger can be a proximity sensor or one of a wide variety of event triggers as understood by those of ordinary skill in the art. After the triggers are defined and initialized, a current GPS location is determined at the mobile device. A determination is then made to determine if the current GPS location is outside the range defined earlier by the GPS trigger. If the mobile device is not outside that range, then flow returns to obtain a new GPS location. If the mobile device is outside that range then, a current LPWN connection information (e.g., proximity sensor or the like) is then determined. If it is determined that an LPWN trigger has occurred, then an event such as a warning message of the type discussed above is executed, otherwise flow returns to obtain another current GPS location of the mobile device.

In yet another aspect, an embodiment may provide a proximity notification system comprising: a first device with a global positioning system (GPS); a second device having a proximity connection with the first device, wherein the first device generates a message for a user of the first device upon the GPS detecting that the first device has moved from a predetermined area and the proximity connection between the first device and the second device has been lost.

Another aspect may include an embodiment providing a proximity notification system comprising: an electronic first device with a global positioning system (GPS); a first trigger defined by an operator associated with the electronic first device; a second device; a proximity connection between the first device and the second device; a second trigger defined by the operator associated with the second device; and wherein the first device notifies the operator when the GPS detects that a first trigger event has occurred and a second event trigger has occurred.

Another aspect may include an embodiment providing a method for notifying based on proximity between devices comprising the steps of: defining a first trigger event in an electronic first device having a global positioning system (GPS); defining a second trigger event; obtaining the coordinates of the first device from the GPS; determining whether the first event trigger has occurred, wherein the first event trigger is based, at least partially, on GPS coordinates locations of the first electronic device and if the first event trigger has not occurred then reobtaining GPS coordinates of the electronic first device; wherein the second trigger is associated with a proximity connection between the first device and the second device; determining whether the second trigger event has occurred and if the second trigger has not occurred then reobtaining GPS coordinates of electronic first device; and when the second trigger has occurred, then sending a notification to an operator after the first and second trigger events have occurred.

### BRIEF DESCRIPTION OF THE SEVERAL VIEWS OF THE DRAWINGS

A sample embodiment of the disclosure is set forth in the following description, is shown in the drawings and is particularly and distinctly pointed out and set forth in the appended claims. The accompanying drawings, which are fully incorporated herein and constitute a part of the specification, illustrate various examples, methods, and other example embodiments of various aspects of the disclosure. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 illustrates an example embodiment of a proximity notification system;

FIG. 2 illustrates a second example embodiment of a proximity notification system;

FIG. 3 illustrates a third example embodiment of a proximity notification system;

FIG. 4 illustrates a fourth example embodiment of a proximity notification system; and

FIG. 5 illustrates an embodiment of a method for proximity notification.

Similar numbers refer to similar parts throughout the drawings.

### DETAILED DESCRIPTION

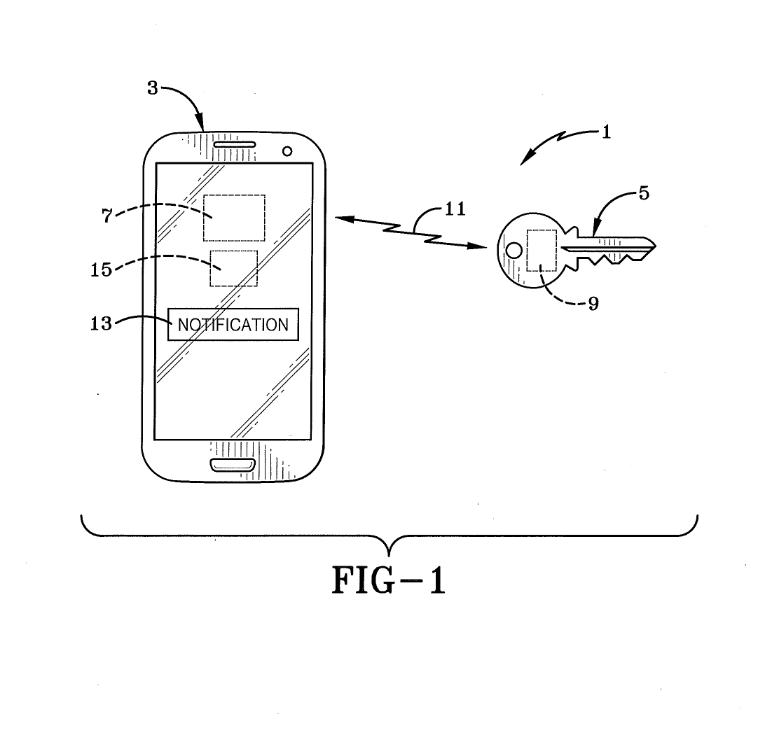

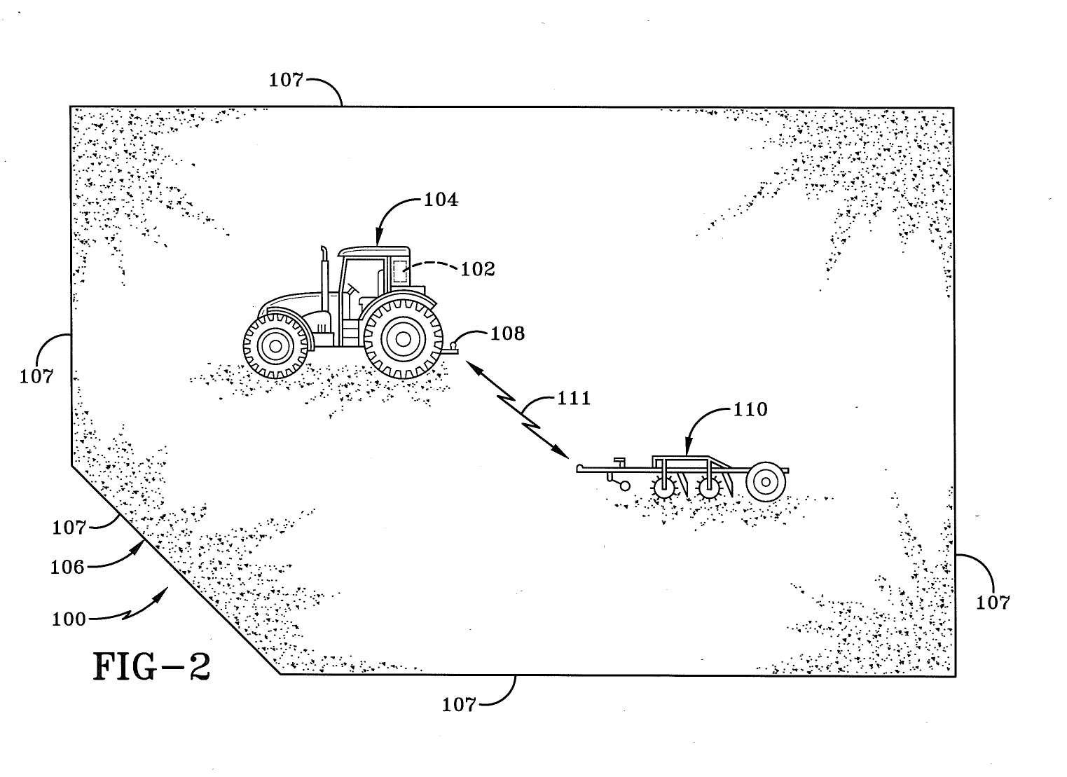

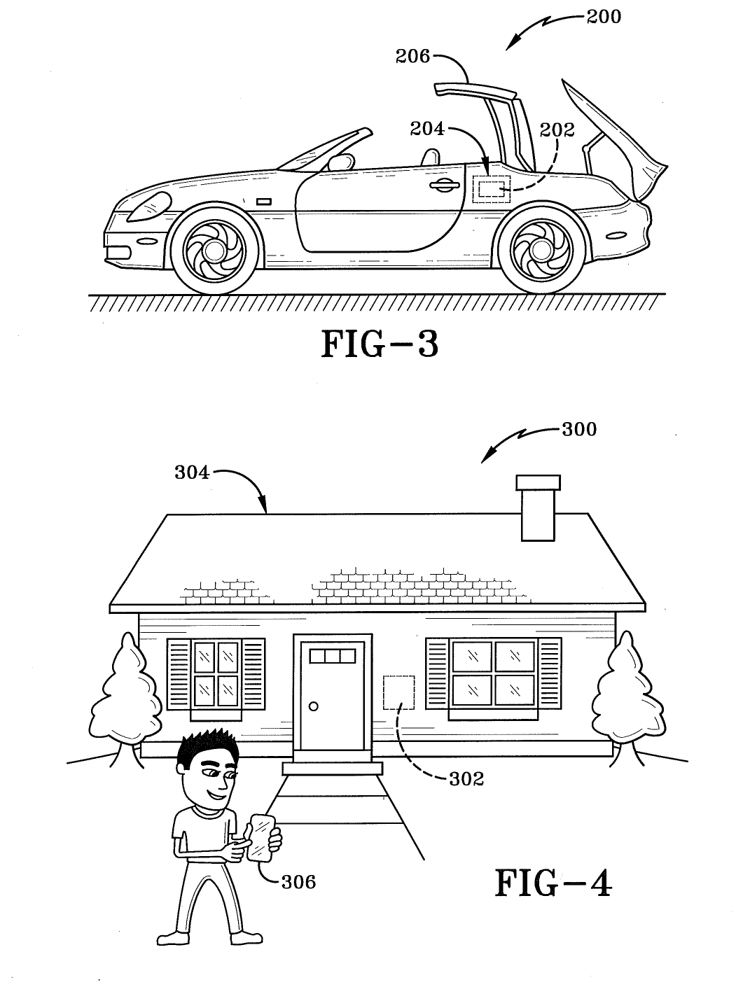

FIG. 1 illustrates the example embodiment of a system 1 that generates a notification 13 based on a global positioning system (GPS) 7 and device state triggers. The example system 1 includes a wireless electronic device 3 which can be a mobile phone and the state trigger 9 which can be in a key 5. The wireless device 3 (mobile phone) includes a global positioning system (GPS) 7 built into it and the key 5 includes a state trigger 9 built into it. In other embodiments and as discussed below, the mobile phone could be any mobile electronic device such as a laptop computer, iPad and the like and the key 5 could be any device with a state trigger built into it. For example, the state trigger 9 could be a low power wireless connection that communicates over wireless link 11 with the wireless device 3. For example, this link can be a version of a Bluetooth link. However, the state trigger 9 could be a variety of other triggers such as a trigger indicating no wagon is connected to a tractor (see FIG. 2), a convertible roof is down (see FIG. 3), and so on.

Notification 13 is depicted in FIG. 1 as being a pop up or text message visually represented on the touch screen of electronic device 3. In this exemplary embodiment, notification 13 is embodied on first device 3 and in other exemplary embodiments an additional notification may be coupled with second device 5 which is a key.

Having described the components of the example system of FIG. 1, their use and operation are now described. In the example embodiment, an owner of the phone 1 would program into the GPS 7 of their phone 3 the boundary coordinates that the owner desires to set a limit on which would define an area associated with an event trigger using a software application (app) or in another way as understood by one of ordinary skill in the art. Next, a low power wireless connection is made over communications link 11 between the key 5 and the mobile phone. In one particular embodiment, the state trigger 9 may also be programmable to recognize the area coordinates programmed in GPS 7 of electronic device 3. State trigger 9 within second device 5 (also referred to as key 5) may also associate with the coordinates bounding the area provided by GPS 7. Now, as long as the mobile phone is within a GPS range of their home or the set area, the system 1 will not generate an alarm or another type of message 13. However, if the owner of the phone leaves their home then a GPS trigger (potential GPS alarm) is generated. If the system 1 also detects that the communication link 11 between the phone 3 and key 5 has been lost because the phone 3 has been moved far enough away from the key 5, then a message 13 will be generated reminding the owner of the phone to go back and get their key. For example, the massage can say “left home without your keys”. The message 13 can be an email message automatically generated and sent to their phone 3, a text message, an audio alarm sound from the phone and/or flashing screen or LEDs on the phone, or another type of message/warning as understood by those of ordinary skill in this art.

The low power wireless network is formed between the first electronic device 3 and the second electronic device 6 via communication link 11 wherein the two devices collect data via the event triggers when they move within the area defined by the GPS 7. System 1 utilizes a low power wireless network which has a longer lifetime than traditional wireless networks inasmuch as it minimizes power consumption of wireless sensor devices (i.e. first device 3 and second device 5). In one particular embodiment, a low power wireless network may reduce overall power consumption by controlling the active time or (awake time) of first device 3 and second device 5. This may be accomplished by a microcontroller having monitoring logic to monitor and control the active time periods of the device. Triggers may be associated with the monitoring logic to enable the triggers to turn on when other actions are met. For example, sensors within first device 3, such as an accelerometer 15, may sense when first device 3 is moving. The accelerometer 15 may communicate with the GPS 7 to indicate that the first device 3 is moving away from the designated set area around the home. Monitoring logic at that point may activate the wireless network to establish communication links 11 between first device 3 and second device 5. Accelerometer 15 within device 3 being operatively coupled with GPS 7 may assist the low power network by reducing power consumption to indicate to monitoring logic that power consumption can be limited when the device is stable within the set area defined by GPS 7.

In one embodiment, leaving a GPS range of the home (i.e. the predefined area) will not by itself generate a message 13 to be sent. However, if both the GPS 7 range trigger is generated and the communications link 11 is lost with the key 5, then the message/warning 13 will be generated.

In a second configuration, the system 100 of FIG. 2 can include an electronic GPS device 102 that is carried by a famer while he is driving a tractor 104 in his field 106. Of course, the farmer would enter the borders 107 of his field into the electronic GPS 102 device. The state trigger in GPS device 102 can be a switch type of device 108 that indicates if a trailer 110 is connected to the tractor 104. This system 100 would only generate an alarm indicating “a trailer is not connected to your tractor” if both GPS systems detect that the farmer drives the tractor out of his field 106 and the state trigger (switch device 108) detects that no trailer 110 is connected to the tractor 104. In this particular embodiment of the second configuration identified as system 100, field 106 is predefined by GPS 102 as being bound by the edges 107 to predefine the area of field 106.

Similar to the first embodiment, no notification is generated by system 100 if the tractor 104 is leaving field 106 with trailer 110 attached to switch device 108 because for the notification to be sent both the GPS range trigger must leave 106 and a communication link established between switch device 108 and trailer 110 must be lost. Thus, as long as the communication link between state trigger 108 and trailer 110 continues to be established via a good connection, notification will not be generated.

The communication link 111 depicted in FIG. 2 is indicated as coupling state trigger 108 to trailer 110. However, it is to be clearly understood that in a practical application there would be a direct electrical connection between state trigger 108 and trailer 110 via a ball hitch on trailer 104 and an electrically conductive receiver on trailer 110.

In an example third configuration, as illustrated in FIG. 3, a system 200 can include a weather/rain application 202 running on an electronic device 204 and the device 204 can know its location by its built in GPS. The weather application 202 can indicate to the electronic device 204 where it is raining and when the electronic device detects that it is raining at the same position that it is located, a GPS trigger can be activated. An event trigger, such as an indication that the roof of a convertible car is down, can also generate if the roof is not up. Now, the GPS trigger, if it is raining at the electronic device's location, and the event trigger being that the roof 206 is down, can together generate a warning message or a third signal to raise the roof 206 of the car so that its interior does not get wet from approaching rain.

In yet another fourth example configuration as illustrated in FIG. 4, a system 300 can make sure a list 302 has been checked before one is to leave their home 304. In this configuration, a GPS trigger is generated when one leaves the location of their home 304 with an electronic device 306. If the user of the electronic device 306 has checked the list 302 they will indicate so through a software app or in another way as understood by those of ordinary skill in this art. Thus, if a GPS trigger is generated (leaving their home) and there is an event trigger, (no indication that the list was checked) a message or warning will be generated by the electronic device 306 indicating that the person is leaving their house 304 without checking the list.

In other configurations, the state trigger 9 (FIG. 1) can be a physical connection with the wireless electronic device 3. As discussed above, the state trigger can be a physical connection between two (or more) devices such as a tractor 104 and its trailer 110 (FIG. 2). In other configurations, the state trigger 9 can be a wireless signal with a signal strength above a threshold value. In some embodiments, the state trigger 9 could be other devices such as a radio frequency identification RFID device or other devices as understood by those of ordinary skill in the art.

Example methods may be better appreciated with reference to flow diagrams. While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Blocks may be combined or separated into multiple components. Furthermore, additional and/or alternative methodologies can employ additional, not illustrated blocks.

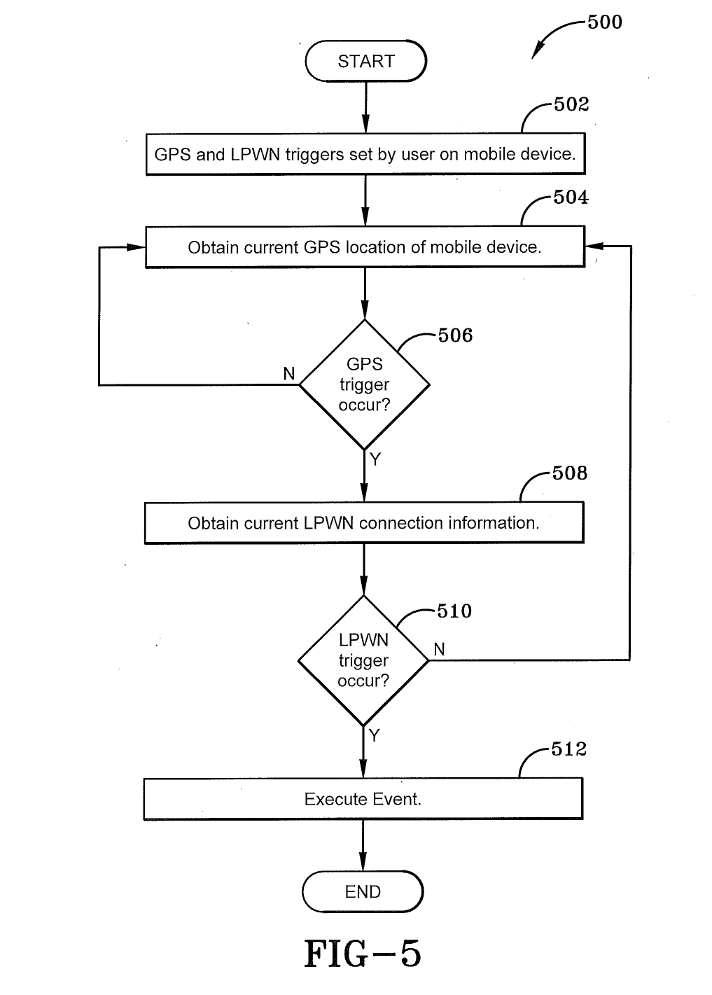

FIG. 5 illustrates a method 500 of determining if a GPS trigger and an event trigger (e.g., state trigger) have both occurred and then generating an appropriate response. The method 500 begins, at 502, by defining a GPS trigger and a low power wireless network (LPWN) trigger as set by a user of a wireless handheld device. As mentioned above, the wireless handheld device could be any device that has GPS capabilities and the LPWN trigger can be a proximity sensor or one of a wide variety of event triggers as understood by those of ordinary skill in the art. After the triggers are defined and initialized, at 502, a current GPS location is determined at the mobile device, at 504. At 506, a determination is made as to if the current GPS location is outside the range defined by the GPS trigger in 502. If the mobile device is not outside that range, then flow returns to obtain a new GPS location, at 504. If the mobile device is outside that range, then a current LPWN connection information (e.g., proximity sensor or the like) is determined, at 508. If it is determined, at 510, that an LPWN trigger has occurred then an event such as a warning message of the type discussed above is executed, at 512; otherwise flow returns to obtain another current GPS location of the mobile device, at 504.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the preferred embodiment of the disclosure are an example and the disclosure is not limited to the exact details shown or described.

What is claimed:

1. A proximity notification system comprising:
a first device with a global positioning system (GPS);
a second device having a proximity connection with the first device, wherein the first device generates a message for a user of the first device upon the GPS detecting that the first device has moved from a predetermined area and the proximity connection between the first device and the second device has been lost.

2. The proximity notification system of claim 1 wherein the proximity connection further comprises:
a network connection.

3. The proximity notification system of claim 1 wherein the proximity connection is a wireless connection.

4. The proximity notification system of claim 1 wherein the proximity connection is a wireless connection above a threshold value.

5. A proximity notification system comprising:
an electronic first device with a global positioning system (GPS);
a first trigger defined by an operator associated with the electronic first device;
a second device;
a proximity connection between the first device and the second device;
a second trigger defined by the operator associated with the second device; and
wherein the first device notifies the operator when the GPS detects that a first trigger event has occurred and a second event trigger has occurred.

6. The proximity notification system of claim 5, wherein the first event trigger is leaving a predefined area established by the user on the electronic first device and the second event trigger is losing the proximity link between the electronic first device and the second device.

7. The proximity notification system of claim 6, wherein the communication link is a wireless connection over a low power wireless network.

8. The proximity notification system of claim 6, wherein the connection link is a direct connection link between two hardware components.

9. The proximity notification system of claim 8, wherein the two hardware components include a first hardware component that is a tractor and a second hardware component that is a trailer and wherein the predefined area is a field.

10. The proximity notification system of claim 5, wherein the first event trigger is a meteorological event based on GPS coordinates of the electronic first device and the second event trigger is a position of a roof on a vehicle.

11. The proximity notification system of claim 10 wherein the meteorological event is rain and the position of the roof is on a convertible car in a collapsed position such that the car cabin is exposed to the rain and when the first event and second trigger events occur, the roof moves from a collapsed position to a closed position to cover the car cabin.

12. A method for notifying based on proximity between devices comprising the steps of:
defining a first trigger event in an electronic first device having a global positioning system (GPS);
defining a second trigger event;
obtaining the coordinates of the first device from the GPS;
determining whether the first event trigger has occurred, wherein the first event trigger is based, at least partially, on GPS coordinates locations of the first electronic device and if the first event trigger has not occurred then reobtaining GPS coordinates of the electronic first device;
wherein the second trigger is associated with a proximity connection between the first device and the second device;
determining whether the second trigger event has occurred and if the second trigger has not occurred then reobtaining GPS coordinates of electronic first device; and
when the second trigger has occurred, then sending a notification to an operator after the first and second trigger events have occurred.

13. The method of claim 12, wherein the step of the determining whether the second trigger event has occurred is accomplished by a establishing a wireless proximity connection between the first and second devices.

14. The method of claim 13, wherein the wireless proximity connection between the first and second devices is a Bluetooth connection and the second device generates a low power wireless network.

15. The method of claim 14, wherein the first device is a smartphone and the second device is a house or car key having a low power wireless network microchip therein.

16. The method of claim 14, wherein the first device is a smartphone and the second device is a list of items within a home to be accomplished by the user after leaving the home.

17. The method of claim 13, wherein the first event trigger is a meteorological event associated with the location of the first device and the second event trigger is a physical state of an automobile.

18. The method of claim 17, wherein the meteorological event is active rainfall and physical state of the second device is an open convertible top on a vehicle.

19. The method of claim 12, wherein the step of determining whether the second trigger event has occurred is accomplished by establishing a physical connection between the first and second devices, wherein the physical connection is a direct connection.

20. The method of claim 19, wherein the first device is a tractor, and the second device is a trailer, and the first event trigger is leaving a field consisting of plants, wherein the step of leaving the field is based on the GPS.
